(19) United States
(12) Patent Application Publication
(10) Pub. No.: US 2016/0298933 A1
(43) Pub. Date: Oct. 13, 2016

(54) ARMORED SUIT

(71) Applicant: UMM AL-QURA UNIVERSITY, MAKKAH (SA)

(72) Inventor: CHARIF MOUSSA BANDE IBRAHIM, MAKKAH (SA)

(21) Appl. No.: 14/685,490

(22) Filed: Apr. 13, 2015

(51) Int. Cl. F41H 1/02; B64D 10/00; A42B 3/22

(52) U.S. Cl. CPC F41H 1/02; A42B 3/228; B64D 10/00

(57) ABSTRACT

The armored suit is adapted to be utilized with a personal flying vehicle. The suit includes a helmet, a body-covering portion, and foot coverings. The helmet includes a metal piece to protect the top of the head, and a movable transparent visor that covers the face of the wearer. The body-covering portion incorporates a chest area member fabricated from a combination of metal and cloth material. Apparatus to assist breathing is attached to the suit. The body covering portion also includes cloth material adapted to cover the lower torso, including the legs. A pair of foot coverings is detachably mounted to the suit.

### BACKGROUND OF THE INVENTION

1. FIELD OF THE INVENTION

The present invention generally relates, to personal protection apparel, and particularly to an armored suit adapted for utilization with a personal flying system.

2. DESCRIPTION OF THE RELATED ART

In many emergency situations it is necessary for the first responders to reach and remove an injured person from sites that are difficult to access. Automotive accidents, airplane crashes, skiing or hiking mishaps, earthquake or flood disasters, etc., present emergency situations that often occur at sites where accessibility is extremely limited. A personal flying vehicle would be an invaluable tool in aiding the removal of an injured person from any of the above-mentioned sites in that the injured person could be secured on the vehicle and flown from the site to a waiting ambulance or other emergency conveyance.

To prevent injury and insure safety for the first responder, protective apparel would be necessary. The apparel should provide protection, especially for the head face and chest areas of the wearer, Thus, an armored suit solving the aforementioned problems is desired.

### SUMMARY OF THE INVENTION

The armored suit is adapted to be utilized with a personal flying vehicle. The suit includes a helmet, a body covering portion, and foot coverings. The helmet includes a metal piece to protect the top of the head, a movable transparent visor that covers the face, and a tube to assist breathing. The body covering portion incorporates a chest area member fabricated from a combination of metal and cloth material, A fabric material is adapted to cover the lower torso including the legs. A pair of foot coverings is detachably mounted to the suit. Apparatus to assist breathing is also attached to the suit.

Accordingly, the invention presents an armored suit that is designed to provide protection for a wearer being transported to and from sites that are difficult to access. Although adapted to be used in conjunction m with a personal flying vehicle, the suit may be employed for use in any emergency situation that might require a protective covering for a user. Although broadly described as adapted for use with a personal flying vehicle, it should be noted that the personal flying vehicle is not part of the invention as disclosed herein. The invention provides for improved elements thereof in an arrangement for the purposes described that are inexpensive, dependable and fully effective in accomplishing their intended purposes.

These and other features of the present invention will become readily apparent upon further review of the following specification and drawings.

### BRIEF DESCRIPTION OF THE DRAWINGS

FIG. 1 is an environmental, front view of an armored suit according to the present invention.

FIG. 2 is a partial, environmental, side view of an armored suit according to the present invention,

FIG. 3 is a partial, front view showing details of the chest area portion of an armored suit according to the present invention.

Similar reference characters denote corresponding features consistently throughout the attached drawings.

### DETAILED DESCRIPTION OF THE PREFERRED EMBODIMENTS

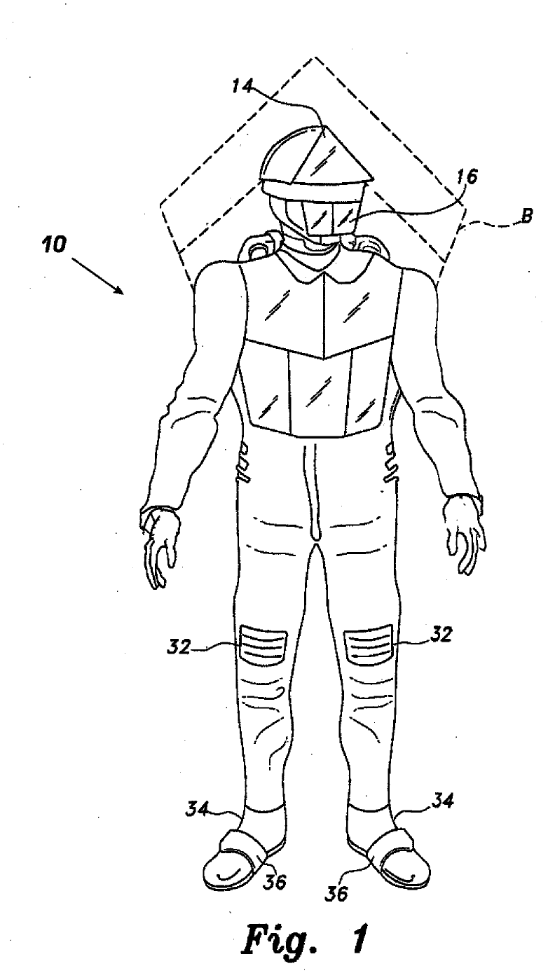

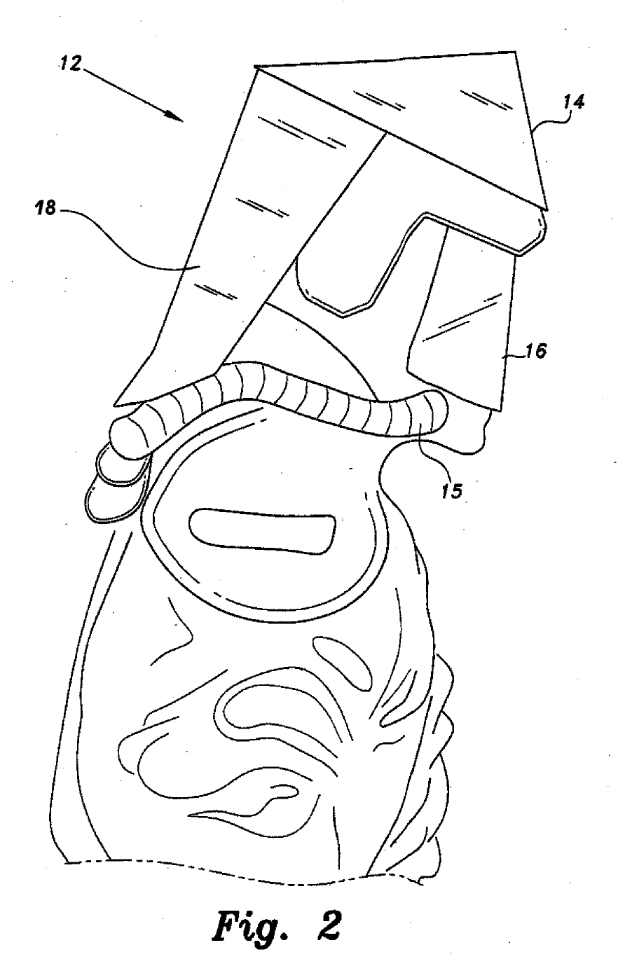

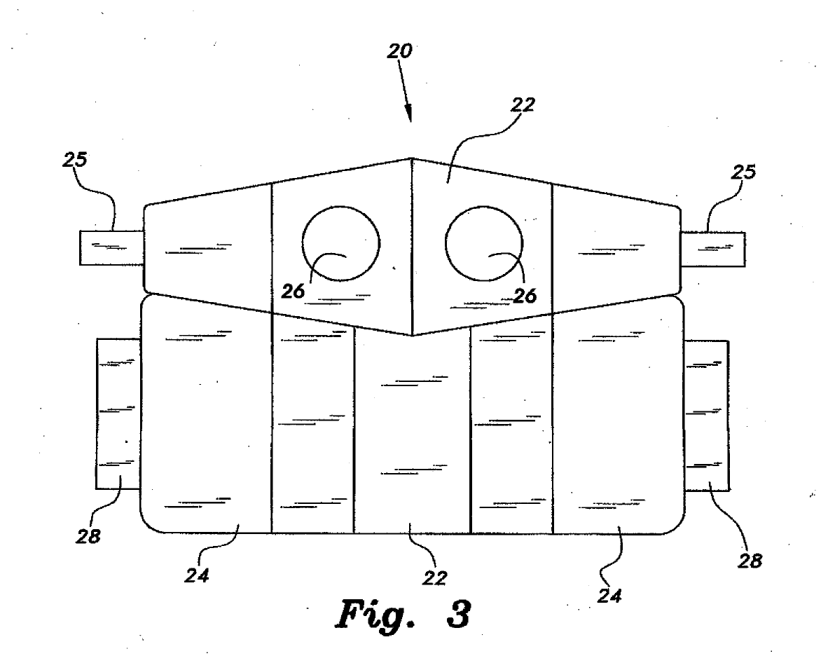

With reference to FIGS. 1-3, the armored suit is generally indicated at 10. The suit 10 comprises a helmet 12 adapted to cover the head of the wearer. The helmet 12 includes a top portion 14 fabricated from metallic material. A transparent visor member 16 is mounted for movement relative to the top portion 14. The visor member 16 is divided in the middle to define two movable panels that can be moved in horizontal directions to cover or uncover the face of the wearer. A cloth member 18 connects the helmet 12 to a chest protective portion, as described below. A breathing assist member 15 extends under the visor 16.

The suit 10 incorporates a chest protective portion 20 fabricated from metal and cloth portions indicated at 22 and 24, respectively. Openings 26 are formed in the chest portion 20 to allow for insertion of the wearer's arms. Straps 25, 28 are provided to fasten the chest portion 20 around the upper torso of the wearer Leg cover members 32 made from cloth are attached to the chest protective portion 20.

Foot covering portions 34 are detachably mounted to the leg portions of the suit. The foot portions 34 include an adjusting strap 36. The suit 10 is attachable to a personal flying vehicle B for the purposes described above.

It is to be understood that the present invention is not limited to the embodiments described above, but encompasses any and all embodiments within the scope of the following claims.

I claim:

1. An armored suit for protecting the head, torso, legs and feet of a wearer, the suit comprising:
a helmet having a top portion and including a visor, the visor being fabricated from a transparent material;
a torso-covering portion fabricated from metallic and cloth materials attached to the helmet;
leg-covering portions attached to the torso-covering portion; and
foot-covering portions attached to the leg-covering portions.

2. The armored suit according to claim 1, wherein the top portion of said helmet is fabricated from metal.

3. The armored suit according to claim 1, wherein said visor is movably mounted to said helmet.

4. The armored suit according to claim 1, further including a respective adjusting strap mounted to each said foot-covering portion.

5. The armored suit according to claim 1, wherein said leg-covering portions are fabricated from cloth material.

6. The armored suit according to claim 1, wherein said visor is constructed in two parts, each of the parts being slidably movable on said helmet.

7. An armored suit for protecting the head, torso, legs, and feet of a wearer, the suit comprising:
a helmet having a top portion fabricated from metal and including a visor, the visor being fabricated from a transparent material;
a torso-covering portion fabricated from metallic and cloth materials attached to the helmet;
leg-covering portions attached to the torso-covering portion; and
a pair of foot-covering portions attached to the leg covering portions.

8. The armored suit according to claim 7, further including a respective adjusting strap mounted to each said foot-covering portion.

9. The armored suit according to claim 7, wherein said leg-covering portions are fabricated from cloth material.

10. The armored suit according to claim7, wherein said visor is constructed in two parts, each of the parts being slidably movable on said helmet.

11. An armored suit for protecting the head, torso, legs, and feet of a wearer, the suit comprising:
a helmet having a top portion fabricated from metal and including a visor, the visor being fabricated from a transparent material;
a torso-covering portion fabricated from metallic and cloth materials attached to the helmet;
leg-covering portions attached to the torso-covering portion, the leg-covering portions being fabricated from cloth material;
a pair of foot covering portions attached to the leg covering portions;
a respective adjusting strap mounted to each of the foot-covering portions; and
a breathing assist member mounted on the suit.

12. The armored suit according to claim 11, wherein said visor is constructed in two parts, each of the parts being slidably movable on said helmet.
